(19) United States
(12) Patent Application Publication
(10) Pub. No.: US 2015/0328713 A1
(43) Pub. Date: Nov. 19, 2015

(54) STAINLESS STEEL, FLUID MACHINE, AND METHOD FOR PRODUCING STAINLESS STEEL

(71) Applicant: Hitachi, Ltd., Tokyo (JP)

(72) Inventors: Mariko MIYAZAKI, Tokyo (JP); Tomio IWASAKI, Tokyo (JP)

(73) Assignee: Hitachi, Ltd., Tokyo (JP)

(21) Appl. No.: 14/689,810

(22) Filed: Apr. 17, 2015

(30) Foreign Application Priority Data
Apr. 21, 2014 (JP) 2014-087609

(51) Int. Cl. B23K 15/00; B32B 15/01

(52) U.S. Cl. CPC B23K 15/0086; B32B 15/011; B33Y 80/00

(57) ABSTRACT

A stainless steel comprises a base metal and a coating material formed on the surface of the base metal, wherein the coating material has a surface on which crystal planes with a maximum atom density orient.

### BACKGROUND OF THE INVENTION

1. Field of the Invention

The present invention relates to a stainless steel, a fluid machine, and a method for producing stainless steel. More particularly, the present invention relates to a stainless steel superior in resistance to cavitation erosion, a fluid machine made of the stainless steel, and a method for producing the stainless steel.

2. Description of the Related Art

Such machines as pumps and steam turbines to handle fluids (which are referred to as fluid machines hereinafter) are usually made of stainless steel which is an iron-based material excelling in mechanical properties and corrosion resistance.

These fluid machines are often subject to cavitation which is a phenomenon that bubbles occur and disappear successively and rapidly in the fluid due to pressure difference in the fluid. The thus formed bubbles break and disappear to give rise to shocks which bring about erosion and cause damage to the surface of the fluid machine. There is a need to prevent this cavitation erosion which shortens the life of the fluid machine.

One way to prevent cavitation erosion is by alteration in the fluid machine structure or by employment of materials excelling in resistance to cavitation erosion.

At present, efforts are being made to develop a new stainless steel superior in resistance to cavitation erosion by focusing on the fact that the intergranular erosion-corrosion that occurs at grain boundaries can be avoided by increasing the grain boundary frequency of the coincidence site lattice grain boundary having a low Σ value.

The term “coincidence site lattice grain boundary” used herein is defined as the grain boundary at which the crystal lattices of two crystal grains (facing each other with the grain boundary held between them) coincide with each other when the two crystal grains are rotated (relative to each other) around the crystal axis. The lattice points which coincide with each other are called “coincidence lattice point”. The Σ value is defined as the ratio between the number density of coincidence lattice points and the number density of original lattice points.

It has been reported in past investigations that the coincidence site lattice grain boundary having a low Σ value has a relatively stable lattice structure and hence contributes to high resistance to cavitation erosion.

One technology to increase the grain boundary frequency of coincidence site lattice grain boundaries having a low Σ value is disclosed in JP-2003-253401-A. According to this disclosure, an austenitic stainless steel is obtained by cold rolling (with a draft of 2-15%) and ensuing heat treatment at 900-1000° C. for 5 hours or more (see claim 3), and it is composed of crystal grains such that the ratio between the length of all grain boundaries and the length of grain boundaries having a Σ value lower than 29 is no less than 75% (assuming the relative bearing of metal crystal grains). (see claim 1.)

Also, Japanese Patent Laid-open No. 2011-168819 (hereinafter, referred to as Patent Document 2) discloses an austenitic stainless steel which is obtained by cold rolling with a draft of 2-5% and ensuing heat treatment at 1200-1500K for 1-60 minutes (see claims 6 to 8) and which has the coincidence site lattice grain boundary frequency with a low Σ value (higher than 75%) and also has an average grain diameter of 40-80 μm (see claim 1).

### SUMMARY OF THE INVENTION

The conventional technology disclosed in JP-2003-253401-A has a disadvantage of requiring heat treatment at 900-1000° C. for 5 hours or longer, which leads to a large energy consumption and cost increase. In addition, such heat treatment gives rise to coarse grains and reduces strength. The technology disclosed in Patent Document 2 also has a disadvantage of resulting in coarse grains (twice as large as grains of base metal) although it saves time for heat treatment.

The technologies disclosed in Patent Documents 1 and 2 are only effective in improving austenitic stainless steel in resistance to cavitation erosion. Improvement in resistance to cavitation erosion is required of other stainless steels (such as ferritic and martensitic stainless steels).

Thus, it is an object of the present invention to provide a stainless steel excelling in resistance to cavitation erosion, a fluid machine, and a method for producing stainless steel.

The stainless steel according to the present invention which is intended to tackle the above-mentioned problem is characterized in being composed of a base metal and a coating material formed on the surface of the base metal, the coating material having the surface which orients in the direction of crystal planes with a maximum atom density.

The fluid machine according to the present invention is characterized in being made of the stainless steel specified above.

The method for producing stainless steel according to the present invention is characterized in forming a coating material on the surface of base metal by using a 3D printer, the coating material orienting in the direction of crystal planes with a maximum atom density.

The present invention provides a stainless steel excelling in resistance to cavitation erosion, a fluid machine, and a method for producing stainless steel.

### BRIEF DESCRIPTION OF THE DRAWINGS

Other objects and advantages of the invention will become apparent from the following description of embodiments with reference to the accompanying drawings in which:

FIG. 1 is a schematic sectional diagram showing the constitution of the stainless steel excelling in resistance to cavitation erosion, which is concerned with the embodiment of the present invention;

FIGS. 2A to 2C are schematic diagrams showing the procedure for forming the surface by using a 3D printer of powder fusion lamination type;

FIG. 3 is a schematic diagram showing one example of the results of X-ray diffractometry applied to the surface of the stainless steel obtained by using a 3D printer of powder fusion lamination type;

FIG. 4 is a schematic diagram showing the method for calculating fracture energy; and

FIG. 5 is a graph showing the results of the calculation of fracture energy which was performed on the (111), (110), and (100) surfaces of γ-iron as a model.

### DESCRIPTION OF THE PREFERRED EMBODIMENTS

The embodiments of the present invention will be described in more detail with reference to the accompanying drawings. Incidentally, those parts common in the drawings are given identical symbols to avoid repeated description.

### <Constitution of the Stainless Steel>

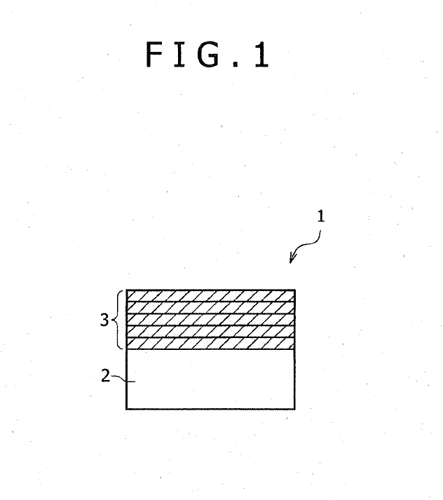

The stainless steel excelling in resistance to cavitation erosion, which is concerned with the embodiment, has the constitution shown in FIG. 1. FIG. 1 is a schematic sectional diagram in which the stainless steel is given the reference number 1.

As shown in FIG. 1, the stainless steel 1 excelling in resistance to cavitation erosion, which is concerned with the embodiment, is constructed of the base metal 2 of stainless steel and the coating material 3 of stainless steel which is formed on the surface of the base metal 2. The surface of the coating material 3 is composed of crystal planes with a substantially maximum atom density.

The base metal 2 is the material from which the fluid machine subject to cavitation erosion is made. It is produced by ordinary casting. The coating material 3 is formed on that part of the base metal 2 which undergoes cavitation erosion. Alternatively, the coating material 3 may be formed on the entire surface of the base metal 2.

The term “crystal plane with a maximum atom density” used herein denotes the (111) plane for austenitic stainless steel having the face-centered cubic structure, the (110) plane for ferritic stainless steel having the body-centered cubic structure, and the (011) plane for martensitic stainless steel having the body-centered tetragonal structure.

In addition, the term “substantially” means that the surface of the coating material 3 is not constituted solely of crystal planes with a maximum atom density. This situation is satisfied if the crystal plane with a maximum atom density exhibits a peak much larger than that of other crystal planes (which is regarded as being at noise levels). This will be described in the later paragraph about X-ray diffractometry.

### <Method for Surface Formation by a 3D Printer of Powder Fusion Lamination Type>

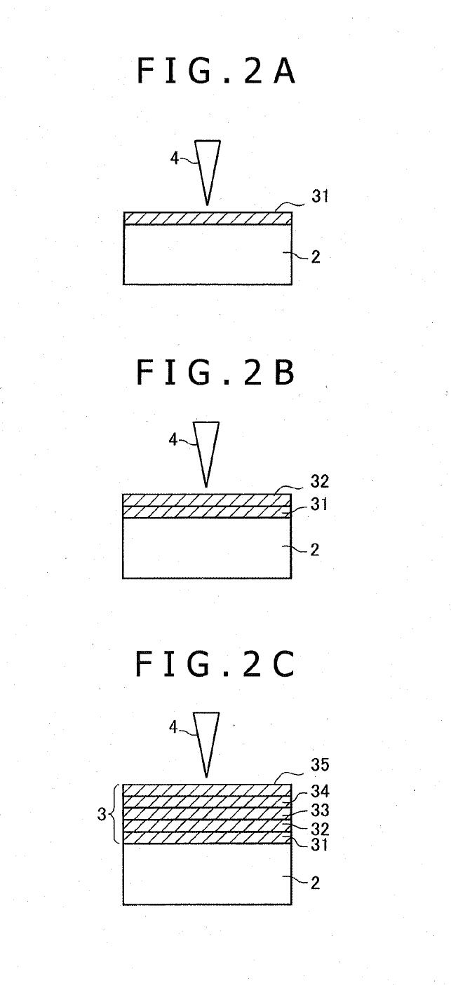

The crystal planes with a maximum atom density can be formed by using a 3D printer of powder fusion lamination type. FIG. 2 is a schematic sectional diagram showing the procedure of forming the surface by using a 3D printer of powder fusion lamination type.

The 3D printer of “powder fusion lamination type” is basically similar in structure to the conventional one of “selective laser sintering (SLS) type”. They differ in the heat source to melt raw materials. That is, the former employs an electron beam 4 (described later), whereas the latter employs a laser beam. They also differ in lamination pitch (or thickness of each coating film). That is, the 3D printer of conventional type performs lamination with a film thickness of about 0.02 mm (20 μm), whereas the one pertaining to the embodiment performs lamination with a film thickness of 100 nm to 1 μm (as mentioned later).

The 3D printer pertaining to the embodiment works as follows. Firstly, it evenly spreads stainless steel powder on the surface of the base metal 2. Then, it irradiates the stainless steel powder with an electron beam 4 for heating and melting. Lastly, it gradually cools the molten stainless steel for solidification. In this way there is formed the first coating film layer 31 of stainless steel, which is 100 nm to 1 μm in thickness. (The coating film layers 32 to 35 to be formed subsequently also have the same thickness as above.) The coating film layer 31 of stainless steel forms in such a way that the crystal plane with a maximum atom density spontaneously orients on the surface owing to the principle mentioned later. (This also applies to the coating film layers 32 to 35 to be formed subsequently as mentioned later.)

In the second step, the 3D printer evenly spreads stainless steel powder on the surface of the coating film layer 31, as shown in FIG. 2B. Then, it irradiates the stainless steel powder with an electron beam 4 for heating and melting. Lastly, it gradually cools the molten stainless steel for solidification. In this way there is formed the second coating film layer 32 of stainless steel. The foregoing procedure is repeated to form as many coating film layers as necessary. FIG. 2C shows the stage in which the procedure has been repeated to form the fifth coating layer 35.

The foregoing procedure makes it possible to form the coating material 3 (consisting of coating laminate layers 31 t0 35) of stainless steal on the surface of base metal 2 by using a 3D printer of powder fusion lamination type, thereby allowing the crystal planes with a maximum atom density to orient on the surface. In other words, the stainless steel 1 is given a coating layer such that the crystal planes with a maximum atom density orient on the surface thereof, as shown in FIG. 1.

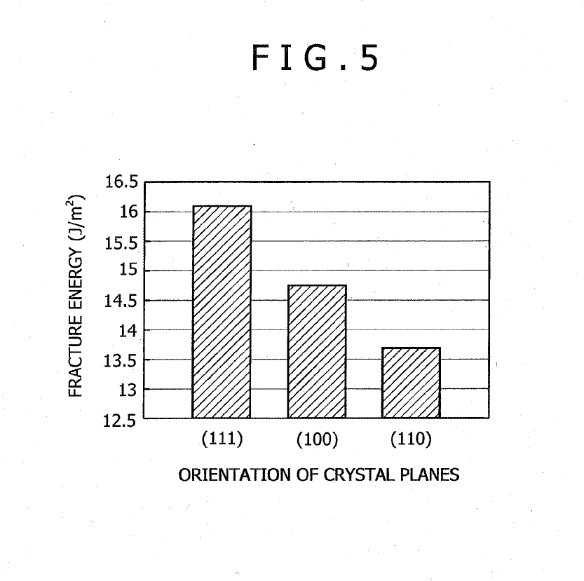

FIG. 5 shows the embodiment in which there are five coating layers. The scope of the present invention is not restricted to this embodiment. The coating layer 3 may be made thicker by increasing the number of laminated coating layers; the thicker the coating layer, the stronger the coating material 3, with improvement in resistance to cavitation erosion. On the other hand, the increased number of coating layers to be laminated leads to more energy consumption and higher production cost. The thickness of the coating material 3 (or the number of layers to be laminated) should be determined according to the desired properties and strength of the fluid machine to which the coating material is applied.

<Principle of Orientation of Crystal Planes with a Maximum Atom Density>

The following describes the principle upon which the surface formed by this embodiment (as shown in FIG. 2) permits the crystal plains with a maximum atom density to spontaneously orient thereon.

Stainless steel produced by ordinary casting, which undergoes rolling and quenching, has the surface with randomly oriented crystal planes because it has no sufficient time for the crystal planes to stably orient on the surface thereof. In fact, it is difficult to control the orientation of crystal planes on the surface.

By contrast, the stainless steel pertaining to this embodiment, which is produced by using a 3D printer of powder fusion lamination type (shown in FIG. 2), has the coating layers 31 to 35 which permit the stable crystal planes with a maximum atom density to orient on the surface thereof because the coating layers are formed from stainless steel powder which is fused and subsequently solidified by slow cooling. The thus formed coating layers 31 to 35 constitute the coating material 3 which permits crystal planes with a maximum atom density to orient on the surface thereof.

Regarding the orientation of crystal planes there has been reported as follows in Non-Patent Document 1 (Technical and Research Report of The Institute of Electronics, Information and Communication Engineers; CPM, electronic parts and materials; Volume 94, Number 39 (1994), 15-19; Titled: Orientation of crystal axes <111> of sputtering film on electrode of Al—Si—Cu semiconductor VLSI, by Tomohisa Okuda et al.). The fact that crystal planes with a maximum atom density orient on the surface is observed in the Al—Si—Cu semiconductor film (800 nm thick) formed by DC magnetron sputtering. This was proven by the X-ray diffractometry which gives only one peak due to the (111) orientation.

The result reported as above is also true in the case of stainless steel. That is, when a powder of stainless steel is deposited up to a thickness of 10 nm to 1 μm by using a 3D printer of powder fusion lamination type, crystal planes with a maximum atom density spontaneously orient on the surface of the coating layers 31 to 35 (or the coating material 3).

Incidentally, if the pitch of lamination exceeds 1 μm (to such an extent as to approach 20 μm which results from the powder sintering method), the crystal planes randomly orient on the surface, producing only limited effects of improving resistance to cavitation erosion. On the other hand, with the pitch of lamination smaller than 100 nm, it is necessary to increase the cycles of lamination to achieve the desired film thickness of the coating material 3, which leads to higher production costs.

Although the pitch of lamination is defined as 100 nm to 1 μm in the foregoing, it is not necessarily restricted to these values. Any thickness of the coating layer is acceptable depending of the material used so long as it is suitable for crystal planes with a maximum atom density to orient on the surface of the coating layer formed by a 3D printer of powder fusion lamination type.

### <Specifying the Orientation of Crystal Planes by X-Ray Diffraction>

The orientation of crystal planes on the surface of the stainless steel 1 can be specified by means of X-ray diffraction. Incidentally, X-ray diffraction is a phenomenon that X-ray is diffracted as the result of scattering and interference by electrons surrounding atoms. Irradiating a specimen with X-rays gives a diffraction pattern which permits one to specify the orientation of crystal planes.

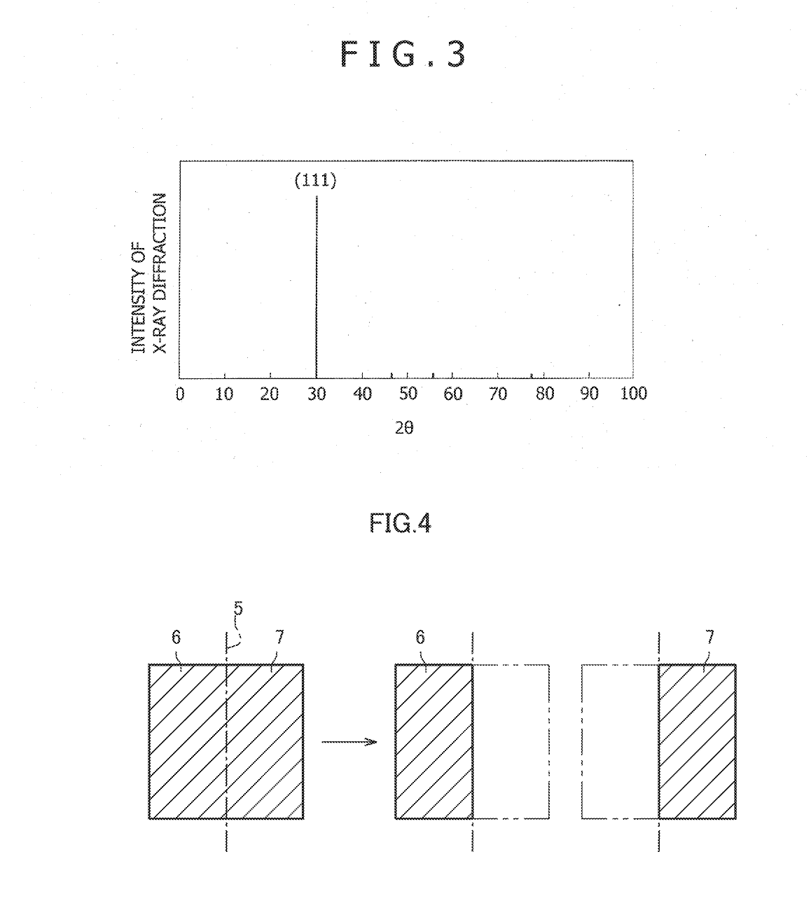

The stainless steel 1 obtained by using a 3D printer of powder fusion lamination type (see FIG. 2) was examined for its surface by X-ray diffraction. The result is graphically shown in FIG. 3, in which the ordinate represents the intensity of X-ray diffraction and the abscissa represents the diffraction angle 2θ.

The test result shown in FIG. 3 is that of austenitic stainless steel. It is noted from FIG. 3 that the peak of X-ray diffraction is merely the one due to the (111) plane and other peaks are as low as noise level. This suggests that the austenitic stainless steel formed by using a 3D printer of powder fusion lamination type has the surface on which the crystal planes with a substantially maximum atom density orient in the direction of the (111) plane.

By the same token, ferritic stainless steel formed by using a 3D printer of powder fusion lamination type has the surface on which the crystal planes with a substantially maximum atom density orient in the direction of the (110) plane, and martensitic stainless steel has the surface on which the crystal planes with a substantially maximum atom density orient in the direction of the (011) plane. (Detailed description and illustration are omitted.)

### <Relationship Between Orientation of Crystal Planes and Strength>

The reason why strength increases at the crystal plane with a maximum atom density was ascertained by analysis based on molecular dynamics simulation. Incidentally, the molecular dynamics is a branch of physics to calculate the position of each atom at each time by solving Newton's equation of motion for individual atoms according to the forces exerted on individual atoms which are calculated from interatomic potential. An explanation of molecular dynamics is found in Non-Patent Document 2 “Benito deCelis, Ali S. Argon, and Sidney Yip: Molecular dynamics simulation of crack tip processes in alpha-iron and copper, Journal of Applied Physics, Volume 54 (1983) 4864-4878”.

The molecular dynamics simulation mentioned below was performed on the model of γ-iron (or iron of face-centered cubic structure) by optimizing the structure until the energy of the system becomes sufficiently stable. The strength was examined by seeking the stable structure of the system and calculating the fracture energy.

The fracture energy is calculated by the method schematically illustrated in FIG. 4.

The fracture energy is defined as energy required to separate the crystal 6 and the crystal 7 from each other (see right side of FIG. 4), which are bound to each other via the fracture plane 5 for which the fracture energy is to be calculated (see left side of FIG. 4). The fracture energy is calculated by (Eₐ+E_{b})−E₀ on the assumption that that the crystals 6 and 7 in their bound state (see left side of FIG. 4) each has an energy E₀ and the crystals 6 and 7 in their separated state (see right side of FIG. 4) respectively have energies Eₐ and E_{b}. The foregoing suggests that the larger the fracture energy, the more difficult the crystals 6 and 7 are to be separated. This means a high strength.

The fracture energy was calculated for the surface of γ-iron (as a model) which has the crystal planes (111), (110), and (100). The results are graphically shown in FIG. 5.

It is noted from FIG. 5 that, in the case of γ-iron, the (111) crystal plane has the highest fracture energy or it is strongest. Here, the (111) plane is the crystal plane with a maximum atom density in the face-centered cubic lattice structure, or it is the most stable crystal plane. Therefore, the (111) plane has a high fracture strength and hence excels in resistance to cavitation erosion.

By the same token, the molecular dynamics simulation for α-iron, which is an iron of body-centered cubic structure, indicates that the (110) plane, which is the crystal plane with a maximum atom density, has the highest fracture energy and hence excels in resistance to cavitation erosion. Also, in the case of iron of body-centered tetragonal structure, the (011) plane, which is the crystal plane with a maximum atom density, has the highest fracture energy and hence excels in resistance to cavitation erosion. (Detailed description and illustration are omitted.)

### CONCLUSION

It is concluded from the foregoing that the fluid machine made of the stainless steel 1 pertaining to the embodiment of the present invention can be made to improve in resistance to cavitation erosion as the result of converting the surface thereof (which is subject to cavitation erosion) into the one composed of crystal planes with a maximum atom density. In addition, the embodiment of the present invention has an advantage over the conventional technology disclosed in Patent Documents 1 and 2 in that the object is achieved by treating merely the surface of the base metal, which leads to an energy and cost saving. Also, the embodiment of the present invention can be applied to all sorts of stainless steel (austenitic, ferritic, and martensitic) for improvement in resistance to cavitation erosion.

In contrast to the fact that conventional 3D printers are used for “shaping” (which is not easily achieved by rapid prototyping, ordinary casting, or the like), the embodiment of the present invention employs a 3D printer to form a high-performance coating layer on the surface of base metal. In other words, the embodiment of the present invention greatly differs from conventional technologies in that it employs a 3D printer to create a special composition (or crystal structure) for desirable “properties”.

What is claimed is:

1. A stainless steel comprising:
a base metal; and
a coating material formed on the surface of the base metal, wherein
the coating material has a surface on which crystal planes with a maximum atom density orient.

2. The stainless steel as defined in claim 1, wherein
the coating material is formed by using a 3D printer.

3. The stainless steel as defined in claim 2, wherein
the 3D printer forms the coating material by laminating coating layers, each of which is formed by melting stainless steel powder by a heat source and slowly cooling to solidify the molten stainless steel.

4. The stainless steel as defined in claim 3, wherein the 3D printer employs electron beams as the heat source.

5. The stainless steel as defined in claim 3, wherein lamination of the coating layers is achieved with a pitch of 100 nm to 1 μm.

6. The stainless steel as defined in claim 1, wherein the stainless steel is austenitic one and the crystal plane with a maximum atom density is the (111) plane.

7. The stainless steel as defined in claim 1, wherein the stainless steel is ferritic one and the crystal plane with a maximum atom density is the (110) plane.

8. The stainless steel as defined in claim 1, wherein the stainless steel is martensitic one and the crystal plane with a maximum atom density is the (011) plane.

9. A fluid machine made with the stainless steel as defined in claim 1.

10. A method for producing a stainless steel comprising:
forming a coating material on the surface of the base metal by means of a 3D printer, the coating material having a surface on which crystal planes with a maximum atom density orient.
